(19) United States
(12) Patent Application Publication
(10) Pub. No.: US 2012/0169046 A1
(43) Pub. Date: Jul. 5, 2012

(54) PIPE COUPLING ASSEMBLY

(76) Inventor: Daniel Edward Bartman, Lawrence Park, PA (US)

(21) Appl. No.: 12/982,947

(22) Filed: Dec. 31, 2010

(51) Int. Cl. F16L 17/00

(52) U.S. Cl. 285/369

(57) ABSTRACT

A pipe coupling assembly for connecting an end of a first pipe to an end of a second pipe, the pipe coupling assembly including a sleeve having a flange disposed at each of opposing first and second ends thereof, each flange defining a flange opening including a seal seat. The seal seat being angularly disposed relative to an axis of the sleeve. The assembly further including, a pair of annular seals, and a pair of compression rings each having a compression lip positionable in one of the flange openings for engaging one of the seals, the compression lip including a substantially flat surface disposed at an angle relative to an axis of the central bore, and a fastener for attaching the compression rings to the flange at each of the first and second ends of the sleeve.

### FIELD OF THE INVENTION

Embodiments of the invention relate generally to a pipe coupling assembly. Other embodiments relate to a pipe coupling assembly for connecting adjoining pipe runs.

### BACKGROUND OF THE INVENTION

Pipe coupling assemblies are generally employed for coupling and sealing aligned flow passages of pipe runs in applications such as, for example, oil and gas production, refining, transportation and other industries. Such pipe coupling assemblies can be annular in configuration having a sleeve section for receiving the ends of adjoining sections of pipe. A ring member is typically provided that is attachable to each end of the sleeve for securing a seal between the ring and the sleeve and thereby providing a sealed joint between each of adjacent sections of pipe and the sleeve.

In use, a damaged section of a pipe can typically be removed and replaced with a new section of pipe coupled to remaining undamaged pipes at each end of the new pipe in a pipe run via a pipe coupling assembly. Thus, a pipe coupling assembly is required at each end of the new section of pipe to sealably connect the new pipe to the undamaged pipes which remain in the pipe run at each of opposing ends of the repair area. Such pipe coupling assemblies must provide an effective pressure tight seal such that a fluid being carried by the pipe run does not leak at the joints provided by the pipe coupling assemblies. Furthermore, the pipe coupling assembly must serve to maintain a leak-proof joint between two adjoining sections of pipe even when external forces create torque and bending effects on the pipes joined together by the pipe coupling assembly. Many prior art pipe coupling assemblies for connecting adjoining pipe runs are unable to provide a flexible leak proof seal and fail quickly if the adjoining pipes are not aligned axially or subjected to forces causing torque or bending effects on one or both of the adjoining pipe runs.

Based on the foregoing, what is needed is an improved pipe coupling assembly for joining adjacent sections of pipes of a pipe run.

### BRIEF DESCRIPTION OF THE INVENTION

Accordingly, an embodiment of the present invention includes a pipe coupling assembly for sealably connecting an end of a first pipe to an end of a second pipe. The pipe coupling assembly includes a sleeve (e.g., elongated sleeve) and two flanges respectively disposed at each of opposing first and second ends of the sleeve. Each flange defines a flange opening including a seal seat for receiving a seal thereagainst. The seal seat defines a substantially flat (e.g., flat but for manufacturing variances) seal seat surface disposed at an angle relative to an axis extending through a center of the length of the sleeve. The pipe coupling assembly also includes a pair of annular seals (each of the seals being positionable over an end of a first pipe and a second pipe respectively) and a pair of compression rings. Each compression ring defines a central bore for receiving an end of one of the first and second pipes therethrough, and each has a compression lip positionable in the flange opening for engaging one of the seals. The compression lip includes a substantially flat compression lip surface disposed at an angle relative to an axis of the central bore. The pipe coupling assembly further includes fasteners for attaching the compression rings to the flanges at each of the first and second ends of the sleeve. In operation, the seal seat and the compression lip cooperate to form two legs of a generally triangular shaped seal opening for retaining an outer portion of one of the seals therein when the compression ring is attached to one of the flanges of the sleeve.

In one embodiment, in the pipe coupling assembly, the seal seat is disposed at an angle in a range of about 45 to about 90 degrees relative to an axis extending through a center of the length of the sleeve.

In another embodiment, the compression lip is disposed at an angle in a range of about 45 to about 90 degrees relative to an axis of the central bore.

In another embodiment, the pipe coupling assembly includes a seal having a tubular outer jacket overlying a compressive resistive core, the compressive resistive core including compressive resistive properties based on the application of use of the pipe coupling assembly. In one embodiment, the seal includes a tubular outer jacket overlying a compressive resistive core including a helical spring.

### BRIEF DESCRIPTION OF THE DRAWINGS

The present invention will be better understood from reading the following description of non-limiting embodiments, with reference to the attached drawings, wherein:

FIG. 1 is a sectional view of a pipe coupling assembly in accordance with an embodiment of the invention, taken at Line A-A of FIG. 4, shown as used for coupling adjoining pipes;

FIG. 2A is a sectional view of the pipe coupling assembly of FIG. 1, taken at Line A-A of FIG. 4, shown without the pipes;

FIG. 2B is an detail view of a portion of the pipe coupling assembly of FIG. 2A;

FIG. 3 is a sectional view of a compression ring and seal portion of FIG. 1;

FIG. 4 is a top plan view of the compression ring and seal of FIG. 1;

FIG. 5 is a cross-sectional view of another embodiment of a pipe coupling assembly, show as used for connecting two pipes of different diameters;

FIG. 6 is a perspective view of one embodiment of a seal of the disclosed pipe coupling assembly;

FIG. 7 is a cross-sectional view of the seal of FIG. 6;

FIG. 8 is a top plan view of another embodiment of a seal of the disclosed pipe coupling assembly;

FIG. 9 is a cross-sectional view of another embodiment of a seal of the disclosed pipe coupling assembly; and

FIGS. 10-12 are schematic views of alternative embodiments of the pipe coupling assembly.

### DETAILED DESCRIPTION OF EMBODIMENTS OF THE INVENTION

Reference will be made below in detail to exemplary embodiments of the invention, examples of which are illustrated in the accompanying drawings. Wherever possible, the same reference numerals used throughout the drawings refer to the same or like parts.

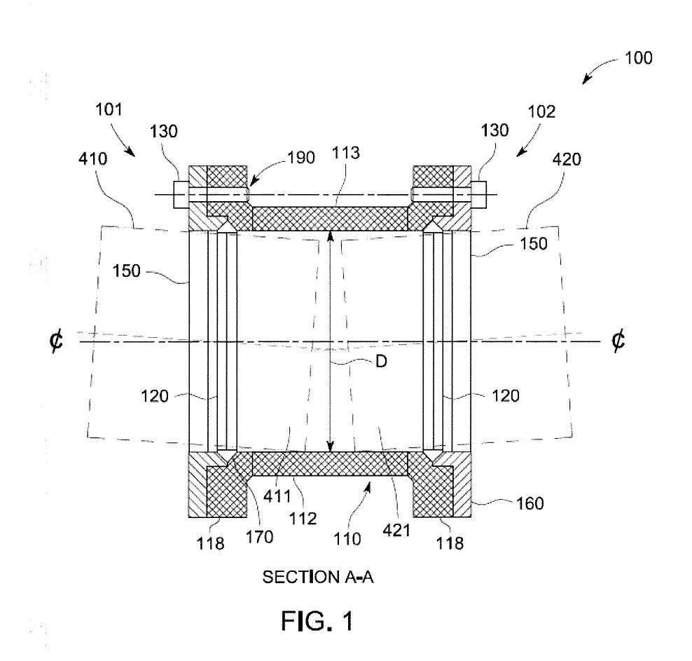

Referring to FIG. 1, a pipe coupling assembly 100 generally provides a connecting element for joining two pipes 410 and 420 in a wide variety of pipe run applications. The pipe coupling assembly 100 has opposing ends 101 and 102, and includes a spool 110 having a generally cylindrical sidewall 112 forming a sleeve 113 disposed about a central axis ¢-¢ and having an inner diameter “D”. The spool 110 further includes a respective annular flange 118 attached at each of opposing ends of the sleeve 113. In the illustrated embodiment, the flange 118 and the sleeve 113 are shown as separate pieces joined together, however, in another embodiment, the sleeve 113 and flanges 118 are integrally formed of the same material.

The pipe coupling assembly 100 includes a respective compression ring 150 attachable to each end of the spool 110 via a plurality of fasteners 130. The compression rings 150 are configured for securing a seal 120 disposed about an end of each pipe 410, 420 between the compression rings 150 and the spool 110 and thereby providing a sealed joint between the pipe coupling assembly and the pipes 410 and 420. The pipe coupling assembly 100 is for use for connecting, in a sealed union, an end of pipe 410 to an end of pipe 420 for carrying a fluid through a pipe run formed by the joined pipes 410 and 420. Since each of the opposing ends 101, 102 of the pipe coupling assembly 100 are substantially the same and include duplicative components, the following description of the pipe coupling assembly is mainly directed to the end 102; however, the description applies equally to the other end 101.

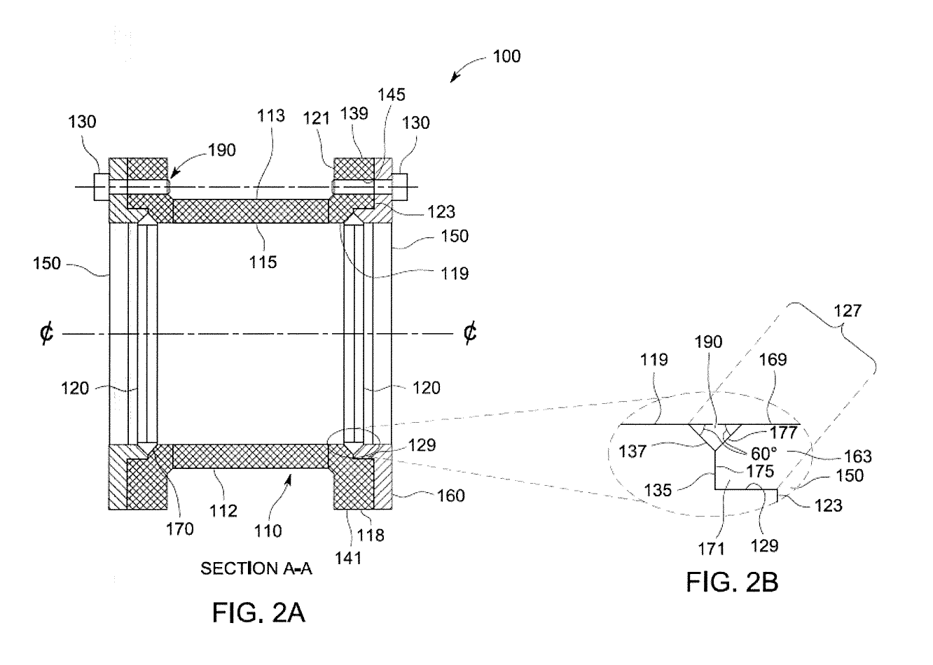

Referring to FIGS. 2A and 2B, the flange 118 is generally ring-shaped (annular), defining axially inner and outer sides 121, 123 respectively. The inner side 121 of the flange 118 is attached to, or adjacent, the sleeve 113, and the outer side 123 faces axially outwardly for engagement with the seal 120 and the compression ring 150. The flange 118 defines an inner bore 119 having a diameter substantially equal to the diameter D of an inner surface 115 of the sidewall 112 of the sleeve 113 and aligned therewith about the axis ¢-¢. (The inner bore and diameter D are sized to accommodate a desired diameter of pipe to be coupled.) The flange 118 further defines a flange opening 127 extending outwardly from the inner bore 119 through the outer side 123 of the flange. The flange opening 127 is defined in part by an outer bore 129 extending inwardly from the outer side 123 of the flange 118 and parallel to a length of the sleeve 113 (parallel to axis ¢-¢), the outer bore terminating at a shoulder 135. The shoulder 135 extends from the outer bore 129 towards the central axis ¢-¢, and is generally perpendicular to the outer bore (and thereby to the central axis ¢-¢). A seal seat 137, for receiving a portion of the seal 120, extends between the inner bore 119 and the shoulder 135. In the illustrated embodiment, the seal seat 137 is a chamfered surface disposed at an angle of about sixty degrees to the inner bore 119 of the flange 118. Thus, the seal seat 137 is or includes a frusto-conical surface (seal seat surface) having a narrowest diameter that coincides with the inner bore 119 of the flange 118, and a widest diameter located axially outwards or away from the narrowest diameter end and coincident with a plane of the shoulder 135. In other embodiments, the seal seat 137 can be disposed at an angle in a range of about 45 degrees to about 90 degrees measured from the inner bore 119 of the flange 118 and/or the axis ¢-¢. In another embodiment, the seal seat 137 is disposed at an angle in a range of 45 degrees to 75 degrees, reflecting 15 degrees either way from 60 degrees, which, according to one aspect, is a suitable range for compressing various types of seals. (In a range of 45 degrees to 75 degrees means 45 degrees, 75 degrees, or a value there between.)

As shown in FIG. 2B, the flange opening 127 includes the adjoining seal seat 137, the shoulder 135, and the outer bore 129. The flange 118 further defines an annular collar 139 extending radially from the outer bore 129 to a rim 141. The collar 139 extends axially between the inner and outer sides 121 and 123 of the flange 118 and defines a plurality of axially extending bolt holes 145 for receiving the fasteners 130. The bolt holes 145 are spaced circumferentially about the collar 139. In the illustrated embodiment the bolt holes 145 are spaced apart, approximately 60 degrees center to center about the axis ¢-¢, such that six bolt holes are defined in the collar 139 for use in attaching the compression ring 150 to the collar 139 and flange 118. (See FIG. 4.) In the illustrated embodiment the bolt holes 145 are threaded holes for threadable engagement with corresponding threaded fasteners 130. In other embodiments, the bolt holes 145 are smooth throughout for receiving a bolt and nut type fastener 130.

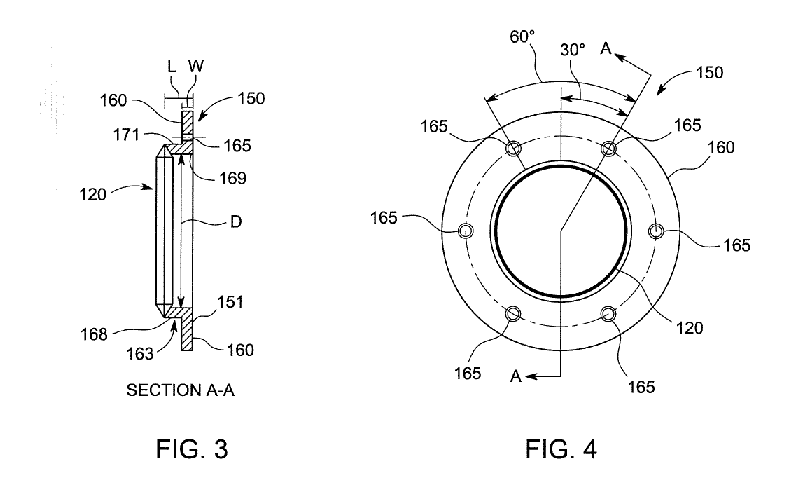

Referring to FIGS. 1-4, the compression rings 150 each comprise a generally L-shaped annular body 151 having a radially outer rim portion 160 and a leg portion 163 extending generally perpendicular to the rim portion at a radially inner diameter of the rim portion. The rim portion 160 defines a plurality of bolt holes 165 disposed circumferentially to align with the bolt holes 145 of the collar 139 for attaching the compression ring 150 to the flange 118. The compression rings 150 can be made from a rigid material such as, for example, a steel material, or other materials depending upon application considerations.

The leg portion 163 extends axially inwardly from the rim portion 160, towards the flange 118 when the compression ring 150 is coupled with the flange as shown in FIG. 1. A radially outer surface 168 of the leg portion 163 has a diameter corresponding to the outer bore 129 of the flange opening 127, such that an end 171 of the leg portion 163 is receivable in the outer bore 129 and for axial alignment therewith about the axis ¢-¢. The leg portion 163 defines a central bore 169 extending through a length L of the compression ring 150. The central bore 169 has a diameter D for alignment with the inner surface 115 of the sidewall 112 of the sleeve 113, as well as the inner bore 119 of the flange 118, when the compression ring 150 is attached to the flange 118. The central bore 169 of the compression ring 150 is aligned with the inner diameter of the sleeve 113 for receiving an end of the pipe 420. As shown in FIG. 1, an end of the pipe 420 will extend through the central bore 169 of the compression ring 150 and the inner bore 119 of the flange 118 and into the sleeve 113.

Referring again to FIGS. 2A and 2B, the leg portion 163 of the compression ring 150 corresponds to the flange opening 127 of the flange 118 for engagement therewith when the compression ring is coupled to the flange 118. The end 171 of the leg portion defines an end surface 175 disposed at an axially inner end of the leg portion and extending generally perpendicular to the central bore 169. The end surface 175 corresponds in length to the shoulder 135 of the flange opening 127 of the flange 118. As shown in FIG. 2B, the end surface 175 of the leg portion 163 of the compression ring 150 abuts the shoulder 135 of the flange 118 when the compression ring is attached to the flange. In other embodiments, and depending in part on the compressibility of the seal 120, the end surface may be spaced apart from the shoulder 135 of the flange when the compression ring 150 is secured to the flange 118 with the compression ring 150 retained therebetween.

The end 171 of the leg portion 163 further defines a compression lip 177 extending between the end surface 175 and the central bore 169. In the illustrated embodiment, the compression lip 177 (defining a compression lip surface) is disposed at an angle of about sixty degrees measured from the central bore of the leg portion 163. As shown in FIG. 2B, when the compression ring 150 is coupled to the flange 118, the compression lip 177 cooperates with the seal seat 137 of the flange 118 to define a seal opening 190 for retaining an outer perimeter of the seal 120 therein. In the illustrated embodiment, the seal opening 190 is generally triangular shaped (in radial cross section) wherein the seal seat 137 and the compression lip 177 cooperate to form two legs of the triangular shaped seal opening. As should be appreciated, the third leg of the triangle shape is defined by the straight-line distance between the two points of the seal seat and compression lip that lie further apart, see, e.g., as indicated by dashed line 196 in FIG. 11. (In an embodiment, the seal opening 190 is substantially triangular shaped in radial cross section, meaning triangular but for manufacturing variances/tolerances. In another embodiment, the seal opening is at least partially triangular in radial cross section, meaning the seal seat and compression lip define therebetween at least three angles of a triangle.)

In other embodiments, the angular position of the compression lip 177 can be different than the angular position of the seal seat 137. For example, the angular position of the seal seat could be about 45 degrees measured from the axis ¢-¢ and the angular position of the compression lip 177 could be about sixty degrees measured from the axis ¢-¢ in an opposite direction. Thus, the resultant seal opening 190 being defined in part by sides of differing lengths forms a generally triangular shape (in radial cross section).

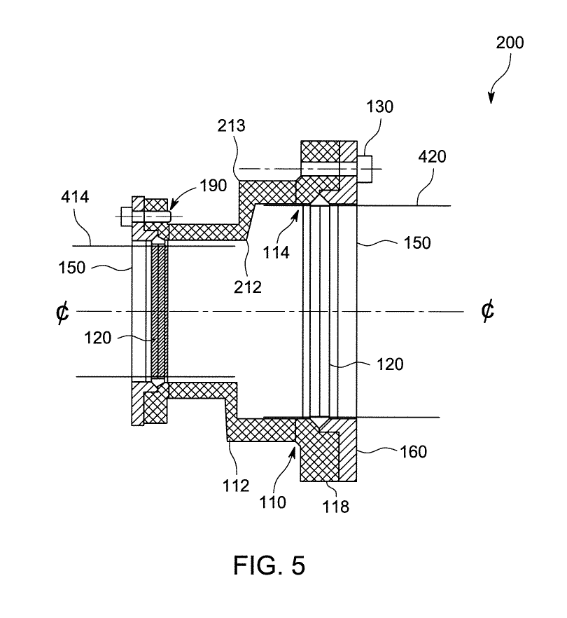

Referring to FIG. 5, a pipe coupling assembly 200 provides a reducer configuration for coupling a pipe 414 to a pipe 420. The components of the pipe coupling assembly 200 are substantially similar to that described above with respect to the pipe coupling assembly 100, the only difference being, the sleeve 213 includes a stepped sidewall 212 corresponding to the variation in the diameters of the pipes 414 and 420, and the end components of the pipe coupling assembly 200 are sized to accommodate the differing diameter of the pipe 414 to be coupled to the pipe 420. Although a stepped transition is shown, the sidewall 212 may instead be configured for a gradual transition, e.g., curved or cone shaped. Thus, in a more general sense, in an embodiment of the pipe coupling assembly 200, the sleeve is graduated from a first inner diameter to a second, different inner diameter.

In further embodiments (not shown), the pipe coupling assembly of the present invention is configured to include various standard pipe fittings and/or related components, such as elbows, tees, y-tees, traps, valves, etc. Thus, the pipe coupling assembly is functional for connecting two pipes for varying applications which are known and/or readily identifiable to one of ordinary skill in the art.

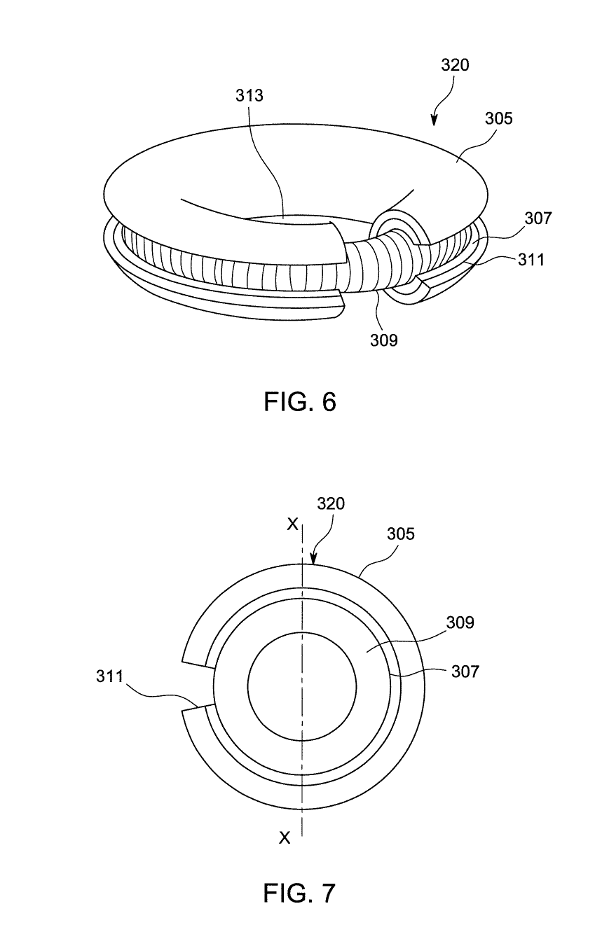

Referring to FIG. 6, one embodiment of the seal 120 includes a spring energized seal 320 including an outer jacket 305 overlaying a helical spring 309. An inner lining 307 is disposed between the helical spring 309 and outer jacket 305. The spring energized seal 320 is of the type manufactured by Garlock GmbH Sealing Technologies of Neuss, Germany, which is a division of Garlock Helicoflex® and Enpro Industries of Charlotte, N.C., United States. The outer jacket 305 is generally a donut-shaped tube defining a central opening 313 for receiving a pipe 410, 420 therein. The seal 320 is sized depending on the size of the flange 118 and/or seal seat 137 thereof and the size (outer diameter) of pipe 410, 420. The outer jacket 305 is typically made of one of aluminum, silver, copper, nickel, and stainless steel depending on the application of the seal 320. The view of FIG. 6 includes a cut-away portion of the outer jacket 305 and inner lining 307 to expose the helical spring 309; however, the outer jacket and inner lining are made continuous throughout the circumference thereof. As further shown in FIG. 6, the outer jacket 305 and inner lining 307 define a spring opening 311 along the entire circumference of the seal 320 for allowing the helical spring 309 to expand in a radially outward direction when the seal is compressed axially such as between the compression ring 150 and flange 118. A cross-sectional view of the seal 320 is show in FIG. 7 including a line X-X showing a preferred direction of compression for the seal.

The seal 320 further includes an elastic core composed of the spring 309 (or a plurality of springs) that acts independently and permits the seal 320 to conform to surface irregularities with respect to the coupling assembly 100. During compression, the specific pressure force created in the spring 309 yields and fills any imperfections associated with the compression ring 150, and or flange 118 and pipe 410, 420, in order to ensure a positive contact with respect to the sealing faces of the coupling assembly 100. The spring 309 associated with the seal 320 may be configured in shape such as for example, helical shape depending upon design considerations. In other embodiments, various shaped springs and/or cores may be utilized in place of the illustrated helical shaped spring 309. The seal 320 can be provided as a mechanical seal that fills the space between two mating surfaces, generally to prevent leakage from or into the joined pipes while under compression.

The spring 309 associated with the seal 320 can be any compression spring that offers resistance to compressive loading and reduces in size on application of an external load. The springs 309 are produced in various sizes and shapes corresponding to the outer jacket 305. The elastic core and/or spring 309 associated with the seal 320 may be configured from a resilient material such as, for example, a polyester or a polystyrene composition including one or more other substantially rigid materials, bonded together. For example, the elastic core of the seal 320 may include fragments of resilient material that include resilient polyurethane foam, but may also comprise latex foam rubber, expanded rubber, or a resilient expanded vinyl resin composition. Alternatively, other types of materials may be utilized in place of, or in combination with the above-identified materials.

The principle of the seal 320 as used in the pipe coupling assembly 100 is based upon the plastic deformation of the seal 320 having greater ductility than the materials of the flange 118 and the and sleeve 113. The seal 320 is compressed between the seal seat 137 of the flange 118. The helical spring 309 of the seal 320 is selected to have a compression resistance depending on the application. During compression, the resulting specific pressure forces the outer jacket 305 to yield and fill any imperfections of the mating surfaces of the flange 118, the sleeve 113 and the associated pipe end 410, 420, while ensuring positive contact with the sealing faces of each of the adjacent surfaces of the flange, sleeve and pipe end. Each coil of the helical spring acts independently and allows the seal to conform to surface irregularities on the mating surfaces. In some embodiments, the outer jacket 305 includes small holes drilled in the tubing wall and exposed to the pressure of the system. The holes enhance the energizing effect of the core by allowing the system pressure to enter the tubing wall. As a result, the pressure inside the seal increases with the system pressure and minimizes the possibility of collapsing of the tubing wall of the seal.

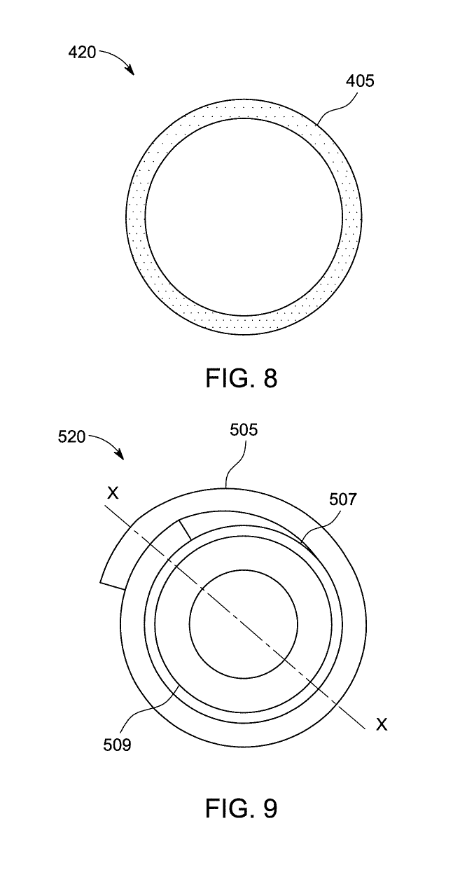

Different variations of seals 420 and 520 are shown in FIGS. 8 and 9 respectively. The seal 420 includes the outer jacket 405 being a continuous donut-shaped tube without the spring opening 311. The seal 420 includes the outer jacket 405 formed of various materials mentioned above with respect to the outer jacket 305 depending on the application of the pipe coupling assembly. The seal 420 includes the outer jacket 405 only without an inner lining and helical spring shown in the seal 320. The seal 420 for use in low to moderate pressure applications.

The seal 520 of FIG. 9 includes a helical spring core 509 covered with an overlapped outer jacket 505. An inner lining 507 is disposed between the outer jacket 505 and helical spring 509. The seal 520 is designed for high pressure applications. FIG. 9 shows the seal 520 in a cross-sectional view including a line X-X showing a preferred direction of compression for the seal.

Referring again to FIGS. 1 and 2, in operation, the pipe coupling assembly 100 is used to sealably connect the end of the pipe 420 to the pipe coupling assembly as follows. First, the compression ring 150 is slid over the end 421 of the pipe 420 with the compression lip 177 facing the end 421 of the pipe 420. Next, the seal 120 is also slid over the end 421 of the pipe and slid down the pipe a distance approximately equal to about half of the length of the sleeve 113 and adjacent the compression ring 150. The seal 120 defines a central opening 113 that is sized corresponding to the size of the pipe 420 to fit snugly over an outer surface of the pipe. Next, the end 421 of the pipe 420 is slid into and through the inner bore 119 of the flange 118 and extending into the sleeve 113 almost to a center of the length of the sleeve. The seal 120 is then moved axially to a position adjacent the seal seat 137 of the flange opening 127 of the flange 118. The compression ring is then moved along a length of the pipe 420 to engage the compression lip 177 with the seal 120. The fasteners 130 are then inserted through the bolt holes 165 of the compression ring and threadably secured in the threaded holes 145 of the flange 118. Uniformly tightening the fasteners 130 compresses the seal 120 in the seal opening 190 causing the seal to expand against and sealably engage the outer surface of the pipe 420 as well as the flange 118 and compression ring 150, thereby forming a sealed union between the pipe 420 and the flange 118 and the sleeve 113.

A similar operation is performed at the other end of the sleeve 113 to couple the end 411 of the pipe 410 to the still open end of the sleeve 113 and corresponding flange 118. Once the pipe coupling assembly 100 is coupled to both of the pipes 410 and 420, a sealed joint is provided between the pipes for carrying a fluid therethrough.

The pipe coupling assembly 100 effectively provides a flexible leak proof seal with respect to the misalignments in pipe run applications. The pipe coupling assembly 100 is designed to provide a leak-proof seal between the pipes 410 and 420 up to an angle of misalignment of about 1.54 degrees therebetween. Further, the pipe coupling assembly 100 provides a sealed joint between adjoining pipes 410 and 420 and will withstand a greater lateral force against the joint when compared with prior art couplers.

The sealing principle of the coupling assembly 100 is based in part on the plastic deformation of the seal 120 having greater ductility than the compression ring 150 and the flange 118. In an embodiment where the seal 120 includes an elastic core (e.g., spring 309), such deformation in the coupling assembly 100 occurs between the sealing face of the compression ring 150 and the elastic core of the seal 120. The elastic core (including the spring 309) includes compression resistance properties to conform to the surface irregularities on the compression ring surface. The compression resistance includes the ability of the elastic core or spring 309 to maintain its shape and hold the ends of the undamaged pipe in a securely coupled relationship when the pipe joint is subjected to external forces that may be acting axially to create torque and bending effects.

The resilient characteristic of the seal 120 associated with the compression ring 150 ensures an elastic recovery during the operations of the pipe coupling assembly 100. Such elastic recovery in the seal 120 permits the coupling assembly 100 to accommodate minor distortions in the pipe runs 410 and 420 due to temperature and pressure cycling. The compression and decompression cycle of the seal 120 is characterized by the gradual flattening of a compression curve. An associated decompression curve is the result of a hysteresis effect and permanent deformation of the spring 309 and the seal ring 120. A combination of elasticity and plasticity in the seal 120 provides a flexible leak proof seal and withstands considerable lateral forces and misalignments in the pipe runs 410 and 420.

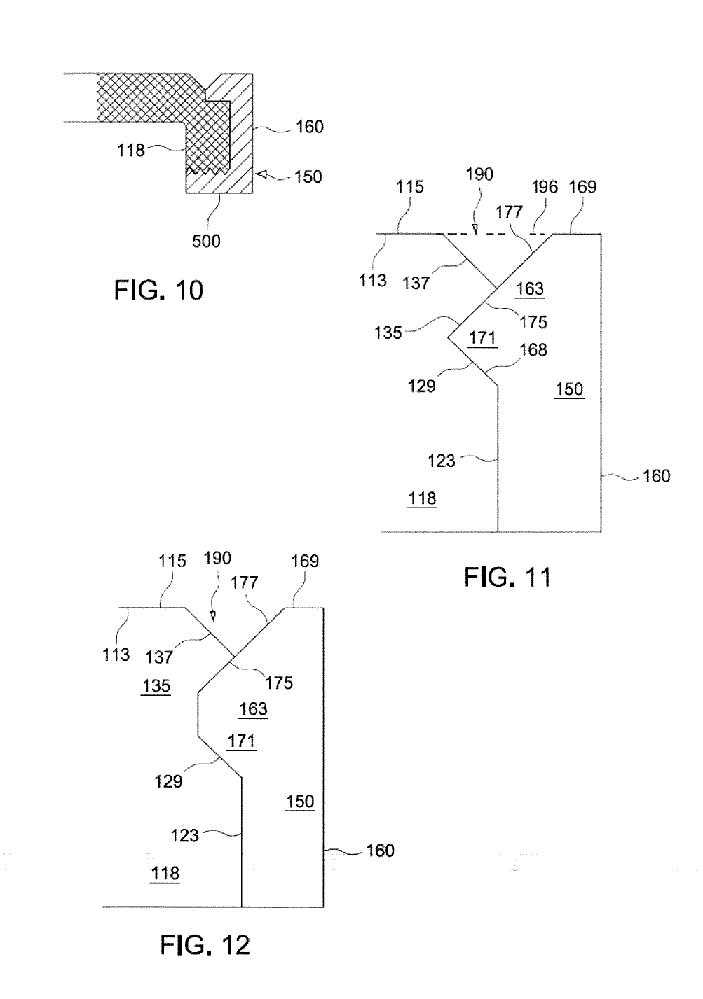

In an embodiment, the compression rings 150 and flanges 118 have corresponding and complementary threads, for a compression ring to be screwed into place onto one of the flanges. (This may be alternatively or in addition to the fasteners 130.) For example, with reference to FIG. 10, each compression ring 150 could be provided with a cylindrical outer cap portion 500, attached to and perpendicular to the outer rim portion 160, which has inner threads that engage threads provided on the radially outermost surface of the flange 118. The term “fastener mechanism” encompasses fasteners 130 (and associated hole structures), integral and complementary threads, and other mechanisms for securely attaching the compression rings 150 to the flanges 118.

In an embodiment, the seal seat 137 and/or the compression lip 177 have curved (e.g., concave) surfaces instead of flat surfaces. Accordingly, unless otherwise specified, the seal seat surface and compression lip surface may be flat, concave, or otherwise.

Although certain embodiments relate to coupling two pipe ends together, other embodiments are configured for coupling to the end of one pipe, for purposes other than connecting to another pipe end axially (end-to-end) in the manner described herein. For example, in one embodiment, a pipe coupling assembly includes a sleeve 113 with one end assembly (flange 118, seal 120, compression ring 150) at a first end of the sleeve, as shown in FIG. 2A, but not necessarily another, similar end assembly at the second end of the sleeve. Instead, in one embodiment, the second end of the sleeve is terminated (capped), for the pipe coupling assembly to act as an end cap. Such an end cap might be useful for capping pipe ends where the end of the pipe is not (or cannot be) provided with screw threads, and/or where it is not desirable to affix an end cap to the pipe through semi-permanent measures such as welding or adhesives. In another embodiment, the other end of the sleeve is a T-junction, or is attached (or attachable) to an assembly or device other than another pipe end. In another embodiment, the second end of the sleeve is provided simply with screw threads, for attachment to a threaded pipe end or other threaded member. Thus, in this embodiment, the pipe coupling assembly would include: a sleeve with first and second ends; the first end having an end assembly as described herein (flange 118, seal 120, compression ring 150); and the second end having threads for attachment to a threaded pipe end or other threaded member. A pipe coupling assembly according to such an embodiment would be useful for attaching a first pipe end (e.g., without threads) to a second, threaded pipe end.

Thus, another embodiment relates to a pipe coupling assembly. The assembly includes a sleeve, a compression ring, and a fastener mechanism. The sleeve has an end, and a flange is attached to the end of the sleeve. The flange defines a flange opening and includes a seal seat for receiving a seal there against. The seal seat is disposed at a first angle relative to a longitudinal axis of the sleeve (e.g., the seal seat defines a seal seat surface disposed at the first angle). The compression ring defines a central bore for receiving an end of a pipe there through, and has a compression lip positionable in the flange opening for engaging the seal. The compression lip is disposed at a second angle relative to an axis of the central bore (e.g., the compression lip defines/includes a compression lip surface disposed at the second angle). The fastener mechanism is configured for attaching the compression ring to the flange of the sleeve, and may be integral with the ring and/or flange (e.g., complementary threads) and/or a separate element or elements (e.g., nuts/bolts or other fasteners and corresponding apertures provided in the ring and flange for receiving the bolts or other fasteners). The seal seat and the compression lip cooperate to form a seal opening for retaining an outer portion of the seal therein when the compression ring is attached to the flange of the sleeve. According to another aspect, when the compression ring is attached to the flange, with a seal in position against the seal seat of the flange, the seal lies within the seal opening and the compression lip compresses the seal against the seal seat and pipe end.

While certain embodiments are characterized in regards to a pipe coupling assembly with a seal, the pipe coupling assembly could be provided for use with a seal, but separate from the seal. That is, the pipe coupling assembly could be provided as a kit, without a seal, for the end user to select the particular seal for use with the assembly. Another embodiment is directed to the pipe coupling assembly including a seal, e.g., an annular seal positionable over the end of the pipe, either as an assembly or kit prior to use, or subsequent to installation.

Another embodiment relates to a pipe coupling assembly. The assembly includes a tubular sleeve 113 having a distal end and a cylindrical inner surface 115, and an annular flange 118 attached to the end of the sleeve. The flange 118 defines a flange opening for receiving an end of a pipe. The flange 118 includes: an annular seal seat 137, contiguous with and extending radially outwards from the cylindrical inner surface 115 and disposed at a first non-zero angle relative to a longitudinal axis ¢-¢ of the sleeve 113; an annular shoulder 135, contiguous with the seal seat 137 and extending radially outwards therefrom; an annular outer bore 129, contiguous with the annular shoulder 135; and an annular outer side 123 contiguous with the outer bore 129. The assembly also includes a compression ring 150. The compression ring 150 defines a central bore 169 for receiving the end of the pipe therethrough, and has an annular radially outer rim portion 160 and an annular leg portion 163 attached to the radially outer rim portion. The leg portion 163 is positionable in the flange opening for engaging a seal 120 when the seal is positioned against the seal seat. The leg portion 163 includes: an annular compression lip 177 contiguous with the central bore 169 and disposed at a second non-zero angle relative to an axis of the central bore; an annular compression ring end 171 (e.g., end surface 175) contiguous with the compression lip 177 and extending radially outwards therefrom; and an annular radially outer surface 168 contiguous with the compression ring end 171. The radially outer surface 168 is dimensioned to abut the outer bore of the flange when the leg portion is positioned in the flange opening. The compression ring end is dimensioned to abut the shoulder of the flange when the leg portion is positioned in the flange opening. The radially outer rim portion is dimensioned to abut the outer side of the flange when the leg portion is positioned in the flange opening. The assembly further includes a fastener mechanism (e.g., 130, 145, 165; 500) for attaching the compression ring to the flange. The fastener mechanism is integral with and/or attached to at least one of the compression ring and flange. When the compression ring is attached to the flange, the seal seat and the compression lip cooperate to form a seal opening for retaining an outer portion of the seal therein. Additionally, the compression ring compresses the seal against the flange.

FIGS. 11 and 12 show alternative embodiments of a pipe coupling assembly, with different flange and compression ring geometries. Since these embodiments are generally similar to those described elsewhere herein, e.g., in the section immediately above, further description is not provided here for the sake of brevity.

Another embodiment relates to a pipe coupling assembly. The assembly includes a tubular sleeve 113 having a distal end and a cylindrical inner surface 115, and an annular flange 118 attached to the end of the sleeve. The flange 118 defines a flange opening for receiving an end of a pipe. The flange 118 includes: an annular seal seat 137, contiguous with and extending radially outwards from the cylindrical inner surface 115 and disposed at a first non-zero angle relative to a longitudinal axis ¢-¢ of the sleeve 113; an annular shoulder 135, contiguous with the seal seat 137 and extending radially outwards therefrom; an annular outer bore 129, contiguous with the annular shoulder 135; and an annular outer side 123 contiguous with the outer bore 129. The assembly also includes a compression ring 150. The compression ring 150 defines a central bore 169 for receiving the end of the pipe therethrough, and has an annular radially outer rim portion 160 and an annular leg portion 163 attached to the radially outer rim portion. The leg portion 163 is positionable in the flange opening for engaging a seal 120 when the seal is positioned against the seal seat. The leg portion 163 includes: an annular compression lip 177 contiguous with the central bore 169 and disposed at a second non-zero angle relative to an axis of the central bore; an annular compression ring end 171 (e.g., end surface 175) contiguous with the compression lip 177 and extending radially outwards therefrom; and an annular radially outer surface 168 contiguous with the compression ring end 171. The radially outer surface 168 is dimensioned to abut the outer bore of the flange when the leg portion is positioned in the flange opening. The compression ring end is dimensioned to abut the shoulder of the flange when the leg portion is positioned in the flange opening. The radially outer rim portion is dimensioned to abut the outer side of the flange when the leg portion is positioned in the flange opening. The assembly further includes a fastener mechanism (e.g., 130, 145, 165; 500) for attaching the compression ring to the flange. The fastener mechanism is integral with and/or attached to at least one of the compression ring and flange. When the compression ring is attached to the flange, the seal seat and the compression lip cooperate to form a seal opening for retaining an outer portion of the seal therein. Additionally, the compression ring compresses the seal against the flange. Further, each of the flange shoulder and the compression ring end is perpendicular to the longitudinal axis of the sleeve and to the axis of the central bore, respectively; the longitudinal axis of the sleeve and the axis of the central bore being co-axial or parallel. The outer bore of the flange is perpendicular to the shoulder and parallel to the longitudinal axis of the sleeve. The radially outer surface of the compression ring is perpendicular to the compression ring end and parallel to the axis of the central bore. Each of the seal seat and the compression lip is substantially flat. Also, each of the first non-zero angle and the second non-zero angle is in a range of 45 degrees to 75 degrees.

Another embodiment relates to a pipe coupling assembly. The assembly includes an annular seal, which is positionable over an end of a pipe, e.g., an inner diameter of the seal corresponds to an outer diameter of the pipe end. The assembly also includes a tubular sleeve and flange, a compression ring, and a fastener mechanism. The sleeve has a distal end and a cylindrical inner surface. The flange is annular and attached to the end of the sleeve. The flange defines a flange opening for receiving the end of the pipe. The flange includes: an annular seal seat, contiguous with and extending radially outwards from the cylindrical inner surface and disposed at a first non-zero angle relative to a longitudinal axis of the sleeve; an annular shoulder, contiguous with the seal seat and extending radially outwards therefrom; an annular outer bore, contiguous with the annular shoulder; and an annular outer side contiguous with the outer bore. The compression ring defines a central bore for receiving the end of the pipe therethrough. The compression ring has an annular radially outer rim portion and an annular leg portion attached to the radially outer rim portion. The leg portion is positionable in the flange opening for engaging the seal when the seal is positioned against the seal seat. The leg portion includes: an annular compression lip contiguous with the central bore and disposed at a second non-zero angle relative to an axis of the central bore; an annular compression ring end contiguous with the compression lip and extending radially outwards therefrom (the compression ring end is dimensioned to abut the shoulder of the flange when the leg portion is positioned in the flange opening); and an annular radially outer surface contiguous with the compression ring end and dimensioned to abut the outer bore of the flange when the leg portion is positioned in the flange opening. The radially outer rim portion is dimensioned to abut the outer side of the flange when the leg portion is positioned in the flange opening. The fastener mechanism is configured for attaching the compression ring to the flange, and is integral with and/or attached to at least one of the compression ring and flange. When the compression ring is attached to the flange, the seal seat and the compression lip cooperate to form a seal opening for retaining an outer portion of the seal therein. Also, the compression ring compresses the seal against the flange.

Another embodiment relates to a pipe coupling assembly. The assembly includes an annular seal, which is positionable over an end of a pipe, e.g., an inner diameter of the seal corresponds to an outer diameter of the pipe end. The assembly also includes a tubular sleeve and flange, a compression ring, and a fastener mechanism. The sleeve has a distal end and a cylindrical inner surface. The flange is annular and attached to the end of the sleeve. The flange defines a flange opening for receiving the end of the pipe. The flange includes: an annular seal seat, contiguous with and extending radially outwards from the cylindrical inner surface and disposed at a first non-zero angle relative to a longitudinal axis of the sleeve; an annular shoulder, contiguous with the seal seat and extending radially outwards therefrom; an annular outer bore, contiguous with the annular shoulder; and an annular outer side contiguous with the outer bore. The compression ring defines a central bore for receiving the end of the pipe therethrough. The compression ring has an annular radially outer rim portion and an annular leg portion attached to the radially outer rim portion. The leg portion is positionable in the flange opening for engaging the seal when the seal is positioned against the seal seat. The leg portion includes: an annular compression lip contiguous with the central bore and disposed at a second non-zero angle relative to an axis of the central bore; an annular compression ring end contiguous with the compression lip and extending radially outwards therefrom (the compression ring end is dimensioned to abut the shoulder of the flange when the leg portion is positioned in the flange opening); and an annular radially outer surface contiguous with the compression ring end and dimensioned to abut the outer bore of the flange when the leg portion is positioned in the flange opening. The radially outer rim portion is dimensioned to abut the outer side of the flange when the leg portion is positioned in the flange opening. The fastener mechanism is configured for attaching the compression ring to the flange, and is integral with and/or attached to at least one of the compression ring and flange. When the compression ring is attached to the flange, the seal seat and the compression lip cooperate to form a seal opening for retaining an outer portion of the seal therein. Also, the compression ring compresses the seal against the flange. Further, each of the seal seat and the compression lip is substantially flat, and each of the first non-zero angle and the second non-zero angle is in a range of 45 degrees to 75 degrees (e.g., 60 degrees).

Another embodiment relates to a pipe coupling assembly. The assembly includes an annular seal, which is positionable over an end of a pipe, e.g., an inner diameter of the seal corresponds to an outer diameter of the pipe end. The assembly also includes a tubular sleeve and flange, a compression ring, and a fastener mechanism. The sleeve has a distal end and a cylindrical inner surface. The flange is annular and attached to the end of the sleeve. The flange defines a flange opening for receiving the end of the pipe. The flange includes: an annular seal seat, contiguous with and extending radially outwards from the cylindrical inner surface and disposed at a first non-zero angle relative to a longitudinal axis of the sleeve; an annular shoulder, contiguous with the seal seat and extending radially outwards therefrom; an annular outer bore, contiguous with the annular shoulder; and an annular outer side contiguous with the outer bore. The compression ring defines a central bore for receiving the end of the pipe therethrough. The compression ring has an annular radially outer rim portion and an annular leg portion attached to the radially outer rim portion. The leg portion is positionable in the flange opening for engaging the seal when the seal is positioned against the seal seat. The leg portion includes: an annular compression lip contiguous with the central bore and disposed at a second non-zero angle relative to an axis of the central bore; an annular compression ring end contiguous with the compression lip and extending radially outwards therefrom (the compression ring end is dimensioned to abut the shoulder of the flange when the leg portion is positioned in the flange opening); and an annular radially outer surface contiguous with the compression ring end and dimensioned to abut the outer bore of the flange when the leg portion is positioned in the flange opening. The radially outer rim portion is dimensioned to abut the outer side of the flange when the leg portion is positioned in the flange opening. The fastener mechanism is configured for attaching the compression ring to the flange, and is integral with and/or attached to at least one of the compression ring and flange. When the compression ring is attached to the flange, the seal seat and the compression lip cooperate to form a seal opening for retaining an outer portion of the seal therein. Also, the compression ring compresses the seal against the flange. Further, each of the flange shoulder and the compression ring end is perpendicular to the longitudinal axis of the sleeve and to the axis of the central bore, respectively. (The longitudinal axis of the sleeve and the axis of the central bore being co-axial or parallel.) Additionally, the outer bore of the flange is perpendicular to the shoulder and parallel to the longitudinal axis of the sleeve, and the radially outer surface of the compression ring is perpendicular to the compression ring end and parallel to the axis of the central bore.

In an embodiment, the flange 118 is annular. In radial cross section (a cross section defined by a radius of the flange), the flange includes a substantially flat inner surface. A seal seat (defining a substantially flat seal seat surface) is contiguous with the inner surface, and extends radially outwards therefrom, i.e., the largest inner diameter of the seal seat is larger than the inner diameter of the inner surface. The seal seat is angled with respect to the inner surface, e.g., in a range from 45 degrees to 90 degrees (or in a range as otherwise specified herein). The seal seat also extends axially outwards from the inner surface, such that an angle between the seal seat and the inner surface extending through the material of the flange is 90 degrees or greater. (Axially outwards means in a direction towards the closest end of the assembly, e.g., to the right from the perspective of FIGS. 11 and 12.) A shoulder (e.g. having a substantially flat shoulder surface) is contiguous with the seal seat, and extends radially outwards from the seal seat. The shoulder may be angled with respect to the seal seat. The shoulder may be perpendicular to the center axis of the flange, or, in other embodiments, it may extend axially outwards from the seal seat or axially inwards from the seal seat. An outer bore (e.g., having a substantially flat outer bore surface) is contiguous with the shoulder, and may be angled with respect to the shoulder. The outer bore extends axially outwards from the shoulder, and may be parallel to the center axis. Alternatively, the outer bore may extend radially outwards from the shoulder. An outer side (e.g., having a substantially flat outer side surface) is contiguous with and angled with respect to the outer bore, and extends radially outwards therefrom. The outer side may be perpendicular to the center axis, or it may extend axially outwards from the outer bore. In any of these embodiments, the indicated structure (inner surface, seal seat, shoulder, outer bore, and outer side) may comprise solely, in radial cross section, a substantially flat surface, without any features deviating from the substantially flat surface. In another embodiment, a compression ring 150 is complementary in shape to the flange 118, but for the compression lip, which is positioned to establish, in conjunction with the seal seat, the seal opening 190, when the compression ring 150 is positioned in place against the flange.

In any of the embodiments herein, the annular seal may have an inner diameter that corresponds to an outer diameter of a pipe to be coupled using the pipe coupling assembly, so that the seal may fit over and snugly engage the pipe outer surface.

In an embodiment, one or both of the seal seat and the compression lip are angled with respect to a center axis in a range of around 45 degrees to around 90 degrees. In another embodiment, one or both of the seal seat and the compression lip are angled with respect to a center axis in a range of around 45 degrees to around 75 degrees. In another embodiment, one or both of the seal seat and the compression lip are angled with respect to a center axis at around 60 degrees. The use of “around” with reference to a degree value means the stated value plus or minus 5%, to account for manufacturing variances or otherwise. In another embodiment, one or both of the seal seat and the compression lip are angled with respect to a center axis in a range of substantially 45 degrees to substantially 90 degrees. In another embodiment, one or both of the seal seat and the compression lip are angled with respect to a center axis in a range of substantially 45 degrees to substantially 75 degrees. In another embodiment, one or both of the seal seat and the compression lip are angled with respect to a center axis at substantially 60 degrees. The use of “substantially” with reference to a degree value means the stated value but for manufacturing variances/tolerances.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. While the dimensions and types of materials described herein are intended to define the parameters of the invention, they are by no means limiting and are exemplary embodiments. Many other embodiments will be apparent to those of ordinary skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” “third,” “upper,” “lower,” “bottom,” “top,” etc. are used merely as labels, and are not intended to impose numerical or positional requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose several embodiments of the invention, including the best mode, and also to enable any person of ordinary skill in the art to practice the embodiments of invention, including making and using any devices or systems and performing any incorporated methods. The patentable scope of the invention is defined by the claims, and may include other examples that occur to those of ordinary skill in the art. Such other examples are intended to be within the scope of the claims if they have structural elements that do not differ from the literal language of the claims, or if they include equivalent structural elements with insubstantial differences from the literal languages of the claims.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

Since certain changes and modifications may be made in the above-described pipe coupling assembly, without departing from the spirit and scope of the invention herein involved, it is intended that all of the subject matter of the above description or shown in the accompanying drawings shall be interpreted merely as examples illustrating the inventive concept herein and shall not be construed as limiting the invention.

What is claimed is:

1. A pipe coupling assembly for sealably connecting an end of a first pipe to an end of a second pipe, the pipe coupling assembly comprising:
a sleeve and a respective flange disposed at each of opposing first and second ends of the sleeve, each flange defining a flange opening including a seal seat for receiving a seal thereagainst, the seal seat defining a substantially flat seal seat surface disposed at an angle relative to an axis extending through a center of the length of the sleeve;
a pair of annular seals, each of the seals being positionable over an end of a first pipe and a second pipe respectively;
a pair of compression rings, each compression ring defining a central bore for receiving an end of one of the first and second pipes therethrough, and having a compression lip positionable in the flange opening for engaging one of the seals, the compression lip including a substantially flat compression lip surface disposed at an angle relative to an axis of the central bore; and
fastener mechanisms for attaching the compression rings to the flanges at the ends of the sleeve;
wherein the seal seat and the compression lip cooperate to form two legs of a generally triangular shaped seal opening for retaining an outer portion of one of the seals therein when the compression ring is attached to one of the flanges of the sleeve.

2. The pipe coupling assembly of claim 1 wherein the seal seat is disposed at an angle in a range of about 45 to about 90 degrees relative to an axis extending through a center of the length of the sleeve.

3. The pipe coupling assembly of claim 1 wherein the seal seat is disposed at an angle of about 60 degrees relative to an axis extending through a center of the length of the sleeve.

4. The pipe coupling assembly of claim 1 wherein the compression lip is disposed at an angle in a range of about 45 to about 90 degrees relative to an axis of the central bore.

5. The pipe coupling assembly of claim 1 wherein the compression lip is disposed at an angle of about 60 degrees relative to an axis of the central bore.

6. The pipe coupling assembly of claim 1 wherein at least one of the seals further comprises a tubular outer jacket overlying a compressive resistive core.

7. The pipe coupling assembly of claim 6 wherein the outer jacket defines at least one hole through a wall thereof for allowing a system pressure to enter the seal.

8. The pipe coupling assembly of claim 1 wherein at least one of the seals further comprises a tubular outer jacket overlying a spring.

9. The pipe coupling assembly of claim 8 wherein said spring is helically shaped.

10. The pipe coupling assembly of claim 1 wherein each compression ring comprises an annular body having an L-shape in radial cross section, the body including an outer rim and a radially inner leg portion, the leg portion further defining the compression lip.

11. The pipe coupling assembly of claim 1 wherein the flange opening further comprises an outer bore terminating at a shoulder, the outer bore extending through an axially outer wall of the flange, the shoulder being disposed between the seal seat and an outer bore of the flange, the seal seat extending radially outward from an inner bore of the flange.

12. The pipe coupling assembly of claim 1 wherein the sleeve is graduated for receiving first and second pipes of differing diameters.

13. A pipe coupling assembly comprising:
a sleeve having an end, and a flange attached to the end, the flange defining a flange opening and including a seal seat for receiving a seal thereagainst, the seal seat disposed at a first angle relative to a longitudinal axis of the sleeve;
a compression ring defining a central bore for receiving an end of a pipe therethrough, and having a compression lip positionable in the flange opening for engaging the seal, the compression lip disposed at a second angle relative to an axis of the central bore; and
a fastener mechanism for attaching the compression ring to the flange of the sleeve;
wherein the seal seat and the compression lip cooperate to form a seal opening for retaining and compressing an outer portion of the seal therein when the compression ring is attached to the flange of the sleeve.

14. The pipe coupling assembly of claim 13 wherein each of the seal seat and the compression lip is flat, and each of the first angle and the second angle is in a range of about 45 degrees to about 75 degrees.

15. The pipe coupling assembly of claim 14 wherein each of the first angle and the second angle is about 60 degrees.

16. The pipe coupling assembly of claim 13 further comprising the seal, wherein the seal is an annular seal positionable over the end of the pipe.

17. A pipe coupling assembly comprising:
a tubular sleeve having a distal end and a cylindrical inner surface, and an annular flange attached to the end of the sleeve, the flange defining a flange opening for receiving an end of a pipe, wherein the flange includes: an annular seal seat, contiguous with and extending radially outwards from the cylindrical inner surface and disposed at a first non-zero angle relative to a longitudinal axis of the sleeve; an annular shoulder, contiguous with the seal seat and extending radially outwards therefrom; an annular outer bore, contiguous with the annular shoulder; and an annular outer side contiguous with the outer bore;
a compression ring defining a central bore for receiving the end of the pipe therethrough, and having an annular radially outer rim portion and an annular leg portion attached to the radially outer rim portion, the leg portion positionable in the flange opening for engaging a seal when the seal is positioned against the seal seat, the leg portion including: an annular compression lip contiguous with the central bore and disposed at a second non-zero angle relative to an axis of the central bore; an annular compression ring end contiguous with the compression lip and extending radially outwards therefrom, the compression ring end dimensioned to abut the shoulder of the flange when the leg portion is positioned in the flange opening; and an annular radially outer surface contiguous with the compression ring end and dimensioned to abut the outer bore of the flange when the leg portion is positioned in the flange opening; wherein the radially outer rim portion is dimensioned to abut the outer side of the flange when the leg portion is positioned in the flange opening; and
a fastener mechanism for attaching the compression ring to the flange, wherein the fastener mechanism is integral with and/or attached to at least one of the compression ring and flange;
wherein when the compression ring is attached to the flange: the seal seat and the compression lip cooperate to form a seal opening for retaining an outer portion of the seal therein; and the compression ring compresses the seal against the flange.

18. The pipe coupling assembly of claim 17 further comprising the seal, wherein the seal is an annular seal positionable over the end of the pipe.

19. The pipe coupling assembly of claim 18 wherein the seal comprises a tubular outer jacket overlying a compressive resistive core including a helical spring.

20. The pipe coupling assembly of claim 17 wherein:
each of the seal seat and the compression lip is substantially flat; and
each of the first non-zero angle and the second non-zero angle is in a range of about 45 degrees to about 75 degrees.

21. The pipe coupling assembly of claim 20 wherein:
each of the flange shoulder and the compression ring end is perpendicular to the longitudinal axis of the sleeve and to the axis of the central bore, respectively, the longitudinal axis of the sleeve and the axis of the central bore being co-axial or parallel;
the outer bore of the flange is perpendicular to the shoulder and parallel to the longitudinal axis of the sleeve; and
the radially outer surface of the compression ring is perpendicular to the compression ring end and parallel to the axis of the central bore.

22. The pipe coupling assembly of claim 20 wherein each of the first non-zero angle and the second non-zero angle is about 60 degrees.
